(19) United States
(12) Patent Application Publication
(10) Pub. No.: US 2024/0309899 A1
(43) Pub. Date: Sep. 19, 2024

(54) Plastic Fastener

(71) Applicant: Carter J. Cammack, Arco, ID (US)

(72) Inventor: Carter J. Cammack, Arco, ID (US)

(21) Appl. No.: 18/182,781

(22) Filed: Mar. 13, 2023

(51) Int. Cl. F16B 21/08; B60R 13/10

(52) U.S. Cl. CPC F16B 21/086; B60R 13/105; B60Y 2304/07

(57) ABSTRACT

An improved push pin style plastic fastener having a head and a threaded shank. The head has a flange having a bottom surface for retaining an object to a substrate. The threaded shank has a first, or top, section and a second, or bottom, section. The second is provided with a void or channel running down the center of the second section of the shank. The void or channel divides the second section of the shank into a series of lobes. The lobes flex inward when the fastener is pushed into aligned openings of the object and substrate. The top section of the threaded shank is solid. As the shank is inserted to the first section, the lobes of the shank reflex or rebound outward to the non-biased position, retaining the plastic fastener in the aligned openings of the object being retained and the substrate.

### FIELD OF THE INVENTION

The presently disclosed technology relates to push in fasteners or connectors. More particularly, the present invention is an improved plastic fastener and system utilizing the improved plastic fastener.

### BACKGROUND OF THE INVENTION

Plastic push pin fasteners are frequently used in the auto industry for connecting two components together, in particular when the components are thin or do not have a female opening that can receive a standard fastener, such as a metal screw. One version of push pin style fasteners use an expanding anchor or base that a shanked fastener is pushed into to cause expansion of the base. A second common push fastener has a series of flexible ribs on the shank. The ribs extend from the shank at an angle toward the fasteners head. The angle of the flexible ribs facilitates insertion of the fastener, but inhibits backing out he fastener unless sufficient force is applied to pull the fastener out.

One example of a use that has not been typical for a push pin style fastener is for securing a license plate to a vehicle. One typical license plates attachment to a vehicle is by bolts that extend through the license plate and through an opening in the license plate holder and/or bumper of the vehicle. On the opposite side of the license plate holder or bumper, a washer and nut are installed on the bolt to retain the bolt in position. This attachment mechanism can be difficult to install because it can be difficult for a vehicle owner to access the area behind mounting position, and difficult to hold the washer and screw in place.

For new vehicles, a license plate placeholder bearing an ornamental display such as a dealer advertisement, is often positioned by the dealer where the final license plate will be. However, it can be difficult for the dealer to install and remove these temporary placeholders because it is difficult to access the area behind the bumper or license plate holder.

Thus what is needed is an improved push in type fastener that is easy to insert by hand, provides secure connection, and easy to remove.

### SUMMARY

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

An improved plastic fastener is disclosed for securing a license plate placeholder to a vehicle. The plastic fastener has a head and a shank extending beneath the head. The head having a flange having a flat lower side. The flat lower side of said flange configured for retaining engagement of a face of a secured object, such as a license plate, to a substrate, such as a vehicle bumper. The head is configured for engagement with a wrench, socket and/or keyed driver such as a screwdriver or hex driver to allow for removal of the plastic fastener. The head can be formed of a typical bolt head configured for use with a socket or wrench, or can be configured similar to a standard screw. The fastener is configured for push insertion, and can be hand removed, while a wrench or other keyed driver can also be used to remove the plastic fastener from the installed position.

A threaded shank extends perpendicular to the flange from the flange to the shank tip. The threaded shank and head are a unitary piece. The threaded shank has a spiral thread extending along the outer surface of the shank along the length of the shank. The shank having a first section and a second section. The first section of the shank extends a first section length from the flange along the length of the shank to a first section end. The first section is solid without a channel. The second section extends from first section end to the shank tip. The second section has a longitudinal void dividing the second section into at least three preferably equal lobes.

Preferably the longitudinal void is in a Y-shape or X-shape allowing for three or four lobes. The longitudinal void separates the lobes in a relaxed position, meaning when the plastic fastener is not being threaded into a license plate and substrate, such as a license plate bracket or a bumper.

The lobes of the threaded shank extend each to a tip. The tip of each lobe is configured in a sloped, threadless configuration such as to provide a tip when the lobes are biased together. The tips of the lobes are configured to be biased together as the plastic fastener is inserted into an opening, The shank is configured such that said lobes compress together as the plastic fastener is pushed into the aligned openings of the license plate placeholder and substrate. The edges of the opening compress the lobes as the force of the rotation of the head of the plastic fastener causes rotation of the shank and spiral thread, threading the plastic fastener through the opening. As the threaded shank is being pushed into the opening the lobes are pushed toward one another, compressing the longitudinal void. As the lobes extend through the opening, the lobes are resilient so as to return to toward the relaxed position. The lobes are configured to rebound outward so as to provide a force retaining the plastic fastener in the opening, and thus retaining the retained object or device on the substrate. When the plastic fastener is fully inserted, opening of the object being retained is adjacent to the first section of the threaded shank, allowing the second or lower section of the shank to have fully and resiliently rebounded.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature

### BRIEF DESCRIPTION OF DRAWINGS

FIG. 1 illustrates an isometric side view of a preferred embodiment of a plastic fastener.

FIG. 2 illustrates a top isometric view of the plastic fastener of FIG. 1. FIG. 3 illustrates a bottom isometric view of the plastic fastener of FIGS. 1-2.

FIG. 4 illustrates a side perspective view of the plastic fastener of the FIGS. 1-3 partially inserted into a license plate and substrate.

FIG. 5 illustrates the plastic fastener fully installed in a license plate and substrate.

FIG. 6 illustrates an exploded view of the faster of FIGS. 1-5, a license plate holder and a license plate installed on a substrate being a bumper.

### DETAILED DESCRIPTION OF THE INVENTION

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

FIG. 1 illustrates a side isometric view of a preferred embodiment of an improved push pin style plastic fastener. The depicted plastic fastener 2 is formed with a head 4 and a shank 10. The head 4 is formed in the depicted embodiment with six sides providing a hexagonal shape. Each side 6 is configured to form a hexagon that is configured for use with a socket for removing the plastic fastener. The head has a flange 8 that is configured to rest against and secure an object being secured, such as against a license plate. The threaded shank extends beneath the flange.

The threaded shank has threads 14 that extend substantially down the shank. The shank is formed of two sections 16, 18. The first section 16 of the threaded shank is a solid section and configured to be positioned within the opening of the object being mounted, such as the openings in a license plate, and the opening of the substrate. The second section 18 of the shank extends from the first section 16 to the tip 12 of the shank, which is formed by the tips of the three or four lobes forming the second section of the shank . The second section 18 is formed with a channel extending longitudinally in the shank. The longitudinal channel divides the shank in the section 18 into a series of lobes 22, 24, 26. In the depicted embodiment, the channels forms a Y-Shape dividing the shank into three lobes separated by the Y-Shaped channel. The shank is formed of a resilient material, preferably a plastic material. The shank is formed such that compression of the tip of each lobe causes the tips to move toward each other, compressing the Y-Shaped channel. In the depicted embodiment, a Y-Shaped channel is utilized separating the shank into three lobes, however alternate shapes can be used such as an X-Shaped channel dividing the shank into four lobes.

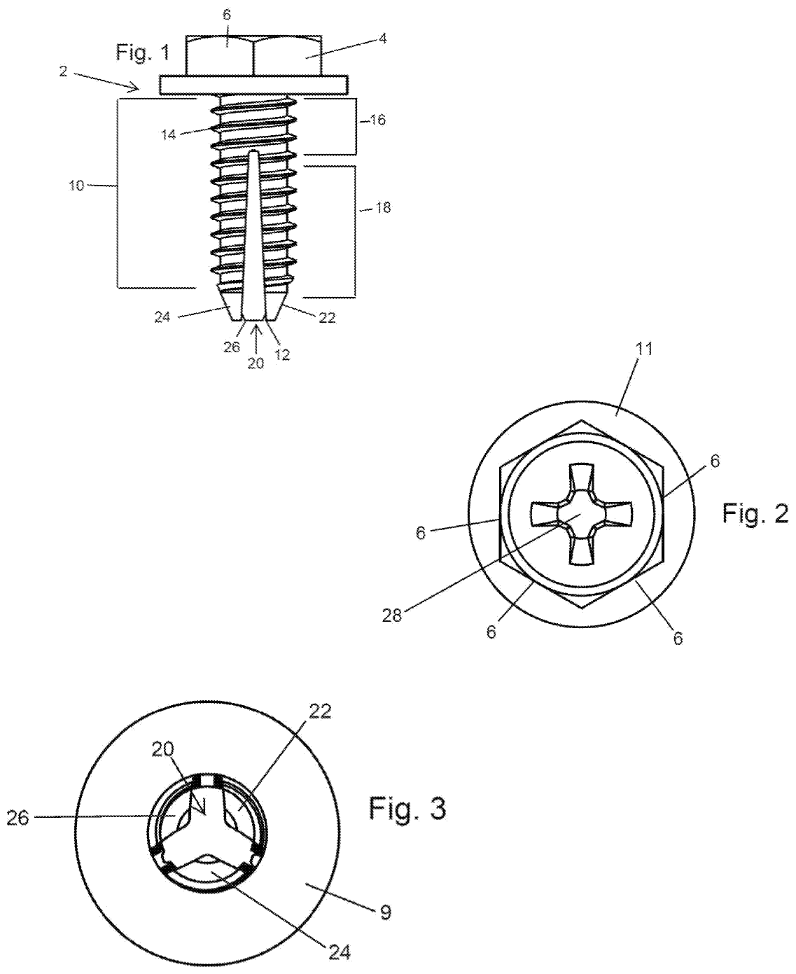

FIG. 2 depicts a top isometric view of the plastic fastener of FIG. 1. The plastic fastener head is formed in a hexagonal shape providing a socket attachment mechanism. A Phillips-head shaped depression 28 is formed at the center of the head, allowing for use of a Phillips-head screwdriver to loosen and tighten the plastic fastener. Alternative plastic fastener shapes such as flatheads, Torx® head, hex key, and other keyed depression can be utilized.

FIG. 3 illustrates a bottom isometric view of the plastic fastener of the FIGS. 1 and 2. FIG. 3 illustrates the Y-Shaped channel 20 positioned longitudinally in the shank. The three lobes 22, 24, 26 are formed by the Y-shaped channel extending longitudinally in the shank. The flange bottom side 9 secures the plastic fastener against an object retained by the plastic fastener, such as a license plate placeholder or license plate holder.

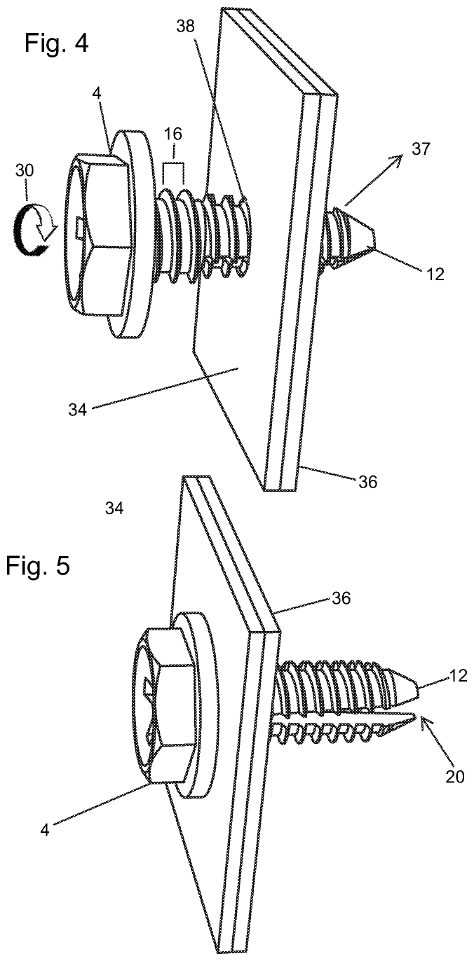

FIGS. 4 and 5 illustrate the plastic fastener of FIGS. 1-3 in an example use. FIG. 4 illustrates the plastic fastener partially installed for securing a license plate 34 to a substrate 36, such as a bumper. The tip 12 of the shank extends through the opening 35 in the license plate and opening in the substrate (not shown). The ends of the lobes of the shank have been compressed together as the tip 12 of the shank is inserted through the aligned openings. To remove the plastic fastener, a socket or screwdriver is utilized to rotate the head in a counter clockwise direction 30 when looking down at the top of the head.

FIG. 5 illustrates the threaded plastic fastener of FIG. 4 securing a license plate 34 to a substrate 36. As the threaded plastic fastener passes through the aligned openings, the elasticity of the material causes the lobes of the shaft to rebound. The rebound of the lobes of the shaft relative to the first section of the shaft secures the threaded plastic fastener position in the aligned openings of the license plate and substrate.

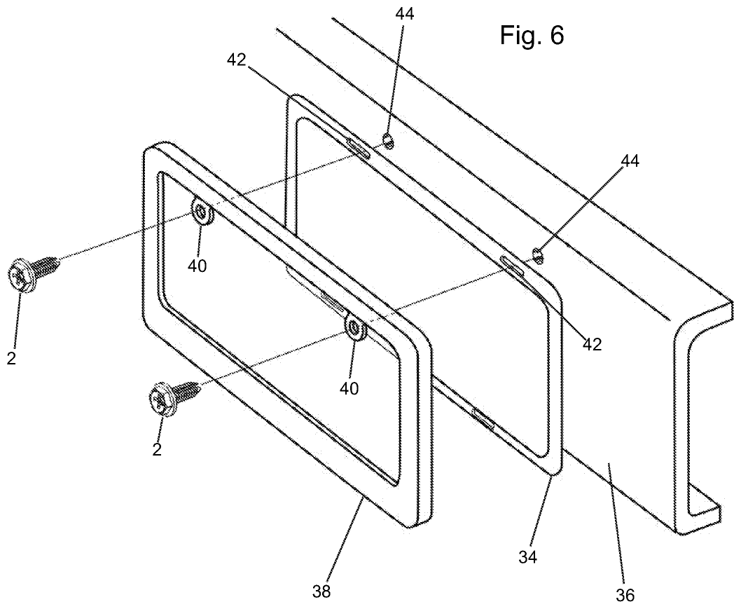

FIG. 6 illustrates an embodiment of the invention in which the plastic fastener is being used to secure a license plate and license plate holder 38 to a substrate being a vehicle bumper. The license plate 34 is shown with openings 42 that are configured to align with the openings 44 in the bumper. An optional license plate holder 38 is provided having openings 40 which align with the opening in the license plate placeholder and the substrate. The plastic fasteners 2 extend through the license plate holder, license plate placeholder and substrate to secure the license plate placeholder and license holder to the substrate.

The plastic fastener provides a reusable, tool-free installation method that can be used a wide variety of instances in which an object is secured to a substrate, such as hanging panels, tags, or signage to shelving.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. A plastic fastener, said plastic fastener comprising:
a head, said head comprising a flange having a flat side, said flat side of said flange configured for retaining engagement of an object to be secured, said head configured for engagement with a wrench, socket and/or keyed driver;
a threaded shank, said shank extending perpendicular to said flange from said shank to a shank tip, said threaded shank comprising a spiral thread extending a length of said shank, wherein said shank comprising a first section and a second section wherein said first section extending a first section length from said flange along said length of said shank to a first section end, and wherein said second section extends from said first section end to said tip, wherein said second section comprises a longitudinal void dividing said second section into at least three lobes, wherein said lobes are separated by said longitudinal void in a relaxed position, wherein said shank is configured such that said lobes compress together by the edges of an opening into which said threaded shank is being threaded and compressing said void, wherein said lobes are resilient to return to said relaxed position as said second section extends beyond said openings.

2. The plastic fastener of claim 1 wherein said head comprises a bolt head.

3. The plastic fastener of claim 1 wherein said bolt head comprises a hexagonal shape.

4. The plastic fastener of claim 1 wherein said bolt head is configured to receive a keyed driver by comprising a keyed recess in a shape configured to receive a screwdriver tip.

5. The plastic fastener of claim 1 wherein said bolt head is configured to receive a keyed driver by comprising a keyed recess in a shape configured to receive a hex driver.

6. The plastic fastener of claim 1 wherein said channel comprises a Y-shape.

7. A method of installing a license plate, said method comprising:
a step of providing a plastic fastener for securing a license plate placeholder to a vehicle, said plastic fastener comprising:
a head, said head comprising a flange having a flat side, said flat side of said flange configured for retaining engagement of a face of a license plate placeholder, said head configured for engagement with a wrench, socket and/or keyed driver;
a threaded shank, said shank extending perpendicular to said flange from said shank to a shank tip, said threaded shank comprising a spiral thread extending a length of said shank, wherein said shank comprising a first section and a second section wherein said first section extending a first section length from said flange along said length of said shank to a first section end, and wherein said second section extends from said first section end to said tip, wherein said second section comprises a longitudinal void dividing said second section into at least three lobes, wherein said lobes are separated by said longitudinal void in a relaxed position, wherein said shank is configured such that said lobes compress together by the edges of an opening into which said threaded shank is being threaded and compressing said void, wherein said lobes are resilient to return to said relaxed position as said second section extends beyond said license plate placeholder and said substrate;
a step of providing a license plate placeholder, said license plate placeholder configured in the shape of a license plate, said license plate placeholder comprising an ornamental display; and
a step of attaching the license plate placeholder to a vehicle, said step comprising aligning said license plate placeholder with the license plate attachment position of the vehicle and screwing the plastic fastener through the license plate placeholder and into an opening in the vehicle configured to receive a license plate attachment fastener.
